(19) United States
(12) Patent Application Publication
(10) Pub. No.: US 2009/0218551 A1
(43) Pub. Date: Sep. 3, 2009

(54) BULK THERMOELECTRIC COMPOSITIONS FROM COATED NANOPARTICLES

(76) Inventors: Suvankar Sengupta, Hillard, OH (US); Ramachandra R. Revur, Columbus, OH (US); Troy Pyles, Hillard, OH (US)

Correspondence Address: HAHN LOESER & PARKS, LLP, One GOJO Plaza, Suite 300, AKRON, OH, 44311-1076, US

(21) Appl. No.: 12/095,476

(22) PCT Filed: Nov. 29, 2006
(86) PCT No.: PCT/US06/45894

§ 371 Date: Nov. 21, 2008

Related U.S. Application Data
(60) Provisional application No. 60/741,021, filed on Nov. 29, 2005.

(51) Int. Cl. H01B 1/10; H01B 1/06; B05D 5/12; H01B 1/22; B22F 1/02

(52) U.S. Cl. 252/512; 252/519.4; 252/500; 427/77; 419/35

(57) ABSTRACT

The invention provides a dense bulk thermoelectric composition containing a plurality of nanometer-sized particles of a thermoelectric material. The bulk composition provides thermoelectric power up to 550 μV/° C. In some embodiments, the surface of each particle is coated by another thermoelectric material. The size of the particles ranges from about 5 nm to about 500 nm. The density of thermoelectric composition ranges from about 80% to about 100% of theoretical density.

This application claims priority to U.S. Provisional Application Ser. No. 60/741,021, filed Nov. 29, 2005 which is incorporated by reference herein in its entirety.

### STATEMENT OF GOVERNMENT INTEREST

This invention was made with government support under the DOE Phase I Small Business Innovation Research (SBIR) Program (Contract No. N00014-05-M-0043). As such, the United States government has certain rights in this invention.

### FIELD OF THE INVENTION

The invention is directed to bulk thermoelectric compositions formed from coated semiconductor nanoparticles, and methods for making such bulk thermoelectric compositions.

### BACKGROUND OF THE INVENTION

A thermoelectric material is a material that can directly convert thermal energy into electrical energy or vice versa. Modem applications of thermoelectric materials range from coolers for infrared detectors and DNA testing, to power supplies for remote locations and space probes.

Among other benefits, thermoelectric materials offer the potential for realizing solid-state cooling without using vapor compression refrigeration or air-conditioning systems. However, traditional thermoelectric materials are less efficient than common vapor-compression systems. Accordingly, there exists a need to improve the efficiency of thermoelectric materials and devices.

The efficiency of a thermoelectric material is characterized in terms of the dimensionless quantity ZT, where T is the average temperature (absolute temperature), and Z is the thermoelectric figure of merit,

Z=S²σ/κ

where S is the thermoelectric power or Seebeck coefficient, σ is the electrical conductivity, and κ is the thermal conductivity. The Seebeck coefficient is a measure of the “thermoelectric pumping power”, i.e., the amount of heat that a material can pump per unit of electrical current. The electrical conductivity is a measure of electrical losses in a material, and the thermal conductivity is a measure of heat that is lost as it flows back against the heat pumped by a material.

Large ZT values are associated with more efficient thermoelectric materials. Large values of Z require high S, high σ, and low κ. Currently, the thermoelectric materials having the highest ZT values tend to be heavily doped semiconductors.

Metals have relatively low thermoelectric power because the thermal conductivity of metals, which is dominated by electrons, is very high. In semiconductors, both phonons (κₚ) and electrons (κ_{c}) contribute to the thermal conductivity with the majority of the contribution coming from phonons, especially at higher temperatures. The phonon thermal conductivity can be reduced by properly engineering defects into the lattice, without too much reduction in the electrical conductivity.

Typically, thermoelectric materials require high doping, to a carrier concentration of approximately 10¹⁹ cm⁻³. State-of-the-art thermoelectric cooling materials are currently based on alloys of Bi₂Te₃ with Sb₂Te₃ (e.g., Bi_{0.5}Sb_{1.5}Te₃, p-type) and Bi₂Te₃ with Bi₂Se₃ (e.g., Bi₂Te_{2.7}Se_{0.3}, n-type) each having a ZT near 1 at room temperature. In such thermoelectric cooling materials, the value of the maximum ZT essentially remains around 1.

Low dimensional structures, such as quantum wells, super-lattices, quantum wires, and quantum dots, offer new ways to manipulate the flow of electrons and phonons in a given material. In the size regime where quantum effects are dominant, the energy distribution of electrons and phonons can be controlled by altering the size of the structures, leading to new ways to manipulate the properties of these materials. In this regime, each low-dimensional structure can be considered a new material, even though the materials may be made of the same atomic structure as its parent material.

When quantum size effects are not dominant, it is still possible to utilize classical size effects to alter the transport processes. For instance, the thermal conductivity can be reduced by exploiting boundary scattering to scatter phonons more effectively than electrons.

For the reasons discussed above, reduced dimensionality is a promising strategy for increasing ZT values. Additionally, the reduced dimensionality provides: (a) a method for enhancing the electron density of states near E_{F} (the Fermi level), leading to an enhancement of thermoelectric power; (b) opportunities to take advantage of the anisotropic Fermi surfaces in multi-valley cubic semiconductors; (c) opportunities to increase the boundary scattering of phonons at the barrier-well interfaces, without a substantial increase in electron scattering at the interface; and (d) opportunities for increased carrier mobility at a given carrier concentration, when quantum confinement conditions are satisfied. For these reasons, considerable effort is being expended on development of thermoelectric materials having structures of reduced dimensionality.

The potential of a low-dimensional system in thermoelectric materials has been exploited in thin films. Two- to three-fold enhancements in ZT values have been demonstrated in PbTe-based quantum-well and quantum-dot systems prepared by molecular beam epitaxy (MBE), and in BiTe-SbTe quantum-well systems prepared by metal-organic chemical vapor deposition (MOCVD). A multilayer quantum well of p-type B₄C/B₉C coupled with a quantum well of n-type Si/SiGe, fabricated on a 5 μm thick Si substrate with ˜11 μm quantum well film thickness, has exhibited a ZT of ca. 4 at 250° C. as a generator, and a ZT of ca. 3 (at 25° C.) when used as a heat pump. Although these gains in thermoelectric power are impressive, preparing thin film thermoelectric materials is not cost-efficient, and there remains a need for high-efficiency bulk thermoelectric materials.

U.S. Patent Application 2004/0187905 to Heremans el al., which is incorporated herein by reference in its entirety, describes bulk thermoelectric materials prepared by sintering semiconductor nanoparticles. The present inventors have made similar discoveries and have made further advances in methods and materials, and the present invention provides even more efficient bulk thermoelectric compositions.

### SUMMARY OF THE INVENTION

The present invention provides dense bulk thermoelectric materials having high ZT values, and methods for manufacturing such materials.

According to one embodiment, the invention provides a dense bulk thermoelectric composition containing a plurality of nanoparticles of a first thermoelectric material. The surface of each particle is coated with a second thermoelectric material. The size of the particles ranges from about 5 nm to about 500 nm. Compression of the particles into a solid mass produces a bulk composition capable of providing thermoelectric power at up to 550 μV/° C. The density of the thermoelectric compositions range from about 80% to about 100% of the theoretical density.

According to another embodiment, the invention also provides a method for manufacturing the dense bulk thermoelectric composition. The method comprises coating a plurality of semiconductor nanoparticles with a second thermoelectric material. In some embodiments, the nanoparticles are synthesized by a sonochemical methodology. In one embodiment, the synthesized nanoparticles are coated by a sonochemical deposition process.

The method also includes densifying the coated particles to form a bulk composition. The densification may be performed by sintering the particles at an elevated pressure and/or at elevated temperature until the desired density and/or thermoelectric properties are obtained.

Among other benefits, the method of the present invention is more amenable to cost-effective, large scale production than are thin-film methods.

According to another embodiment, the invention provides a thermoelectric generator comprising a bulk thermoelectric composition of the present invention, disposed between and in thermal contact with a heat source and a heat sink.

According to another embodiment, the invention also provides a thermoelectric cooler, comprising the bulk thermoelectric composition of the present invention disposed between and in electrical contact with a positive electrode and a negative electrode.

### BRIEF DESCRIPTION OF THE FIGURES

FIG. 1 is a flowchart illustrating a method of making bulk thermoelectric materials from coated nanoparticles.

FIG. 2 is a transmission electron microscopy (TEM) image of coated PbTe nanoparticles prepared according to one embodiment of the invention.

FIG. 3 is a photograph of several hot pressed samples of coated PbTe nanoparticles, prepared according the invention.

FIG. 4 presents TEM images of a coated PbTe nanoparticles prepared according to one embodiment of the invention.

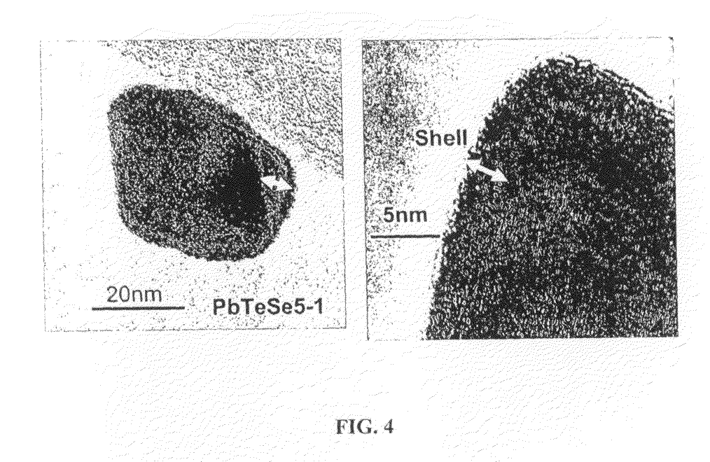

FIG. 5 presents two micrographs showing the microstructure of a fractured surface of a PbTe sample pressed at 250° C. with a pressure of about 30,000 psi. Density was 92% of the theoretical maximum.

FIG. 6 is an illustrational example showing an X-ray diffraction (XRD) pattern for the PbTe nanoparticles according to one embodiment of the invention, with a listing of the crystallite size for selected peaks.

FIG. 7 is an illustrational example showing an XRD pattern of a hot pressed pellet with peaks labeled with the crystallite size.

FIG. 8 is an illustrational example showing an XRD patterns of PbTe material showing effects of sonication times 10, 20 and 30 min, according one embodiment of the invention.

### DETAILED DESCRIPTION OF THE INVENTION

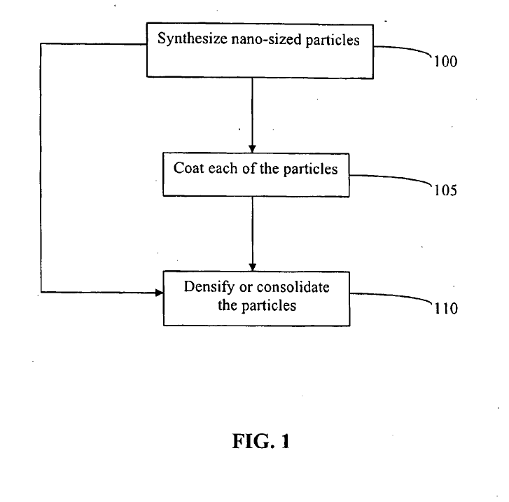

FIG. 1 illustrates a method of making a bulk thermoelectric material having coated nanoparticles. According to one embodiment of the invention, as illustrated in FIG. 1, item 100, a plurality of nanoparticles of a thermoelectric material are synthesized.

In one embodiment, nanoparticles of an undoped thermoelectric material may be synthesized. In another embodiment, nanoparticles of a doped thermoelectric material may be synthesized. Examples of suitable thermoelectric materials include, but are not limited to, PbTe, PbSe, PbS, SnTe, SnSe, EuTe, La₂Te, PbEuTe, BiSb, Bi₂Te₃, Bi₂Se₃, Sb₂Te₃, Sb₂Se₃ and their alloys. Examples also include, but are not limited to, SiGe, Zn₄Sb₃, and CoSb₃. In some embodiments, nanoparticles of alloys, for example, a BiSb-based alloy, may be synthesized.

### Synthesis of Nanoparticles

The uncoated thermoelectric nanoparticles may be synthesized by any methodologies known to one skilled in the art, as taught for example in U.S. Patent Application 2004/0187905. These methods may be categorized into gas-phase processes (e.g., laser ablation and chemical vapor deposition), liquid-phase processes (e.g., thermal and chemical decomposition of organometallic precursors or salts, emulsion-based and sol-gel-based systems, and sonochemical methods), and solid-state methods (e.g., micro-mechanical milling and grinding). For reviews, see O. Masala and R. Seshadri, Ann. Rev. Mat. Res. 34: 41-81 (2004) and J. H. Fendler, and F. C. Meldrum, Advanced Materials 7:607-632 (1995), both of which are incorporated herein by reference. Nanoparticles of certain thermoelectric materials are commercially available (e.g., Evident Technologies, Troy, N.Y.).

Liquid-phase methods are found to be preferable, due in large part to their scalability and reproducibility. Lead oleate and trioctylphosphine selenide can be heated together, for example, forming PbSe nanoparticles. In a preferred embodiment, the nanoparticles are synthesized by a sonochemical methodology, as in the examples below.

The chemical effects of ultrasound are generally thought to arise from acoustic cavitation, which is the formation, growth, and implosive collapse of bubbles in a liquid. The implosive collapse of the bubbles generates a localized hotspot through adiabatic compression or shock wave formation within the gas phase of the collapsing bubble, raising local temperatures to about 5000 K and transient pressures to a few hundred atmospheres. These extreme conditions cause the rupture of chemical bonds, while high cooling rates (e.g., more than 10¹¹ K/sec) on collapse of the bubble tend to limit secondary or side-reactions.

The sonication time typically ranges from about 5 minutes to about 120 minutes. In some embodiments, the particle size is dependent on sonication time. In some embodiments, the sonication time ranges from about 5 minutes to about 45 minutes. In particular embodiments, the sonication time is about 10, 20 or 30 minutes.

Tellurium metal or Te compounds can be used as a nanoparticle precursor. In preferred embodiments, NaHTe is used as a precursor. Solutions of NaHTe are prepared by adding tellurium metal to an aqueous solution of sodium borohydride and stirring the resulting mixture until the tellurium metal is completely dissolved. In a typical process, the required amount of NaHTe solution is then added to a mixture of lead (II) acetate and ethylene glycol with ultrasonic irradiation. The pH is preferably controlled with a suitable base, such as ethylenediamine. Using NaHTe as a precursor, powders having surface areas in excess of 37 m²/g have been obtained.

A number of other processing parameters determine the size, shape and morphology of the particles, as well as the reaction rate and yield. Examples of such parameters include, but are not limited to, sonic frequency, power, solvent vapor pressure, solvent/solution viscosity, temperature, gas atmosphere under which sonication takes place, and pressure of the gas. In some embodiments, additives such as complexing agents and surfactants also affect the size and shape of the particles. It is within the abilities of one skilled in the art to vary these parameters to optimize the particle composition, morphology, and size distribution.

In a milling methodology, the chosen thermoelectric bulk materials may be ground into a coarse powder using a mortar and pestle or other suitable device, and then further ground into a more fine powder with a ball mill, rod mill or the like. In a ball milling process, for example, the coarse powder may be placed in a sealable container along with a solvent, such as n-heptane, and zirconia balls of predetermined diameter (e.g., approximately 1 cm). The container is then rotated using an automatic turning machine or other device to further grind the powder. In one embodiment of the invention, the milling process is performed for a duration of time ranging from about one hour to several days, with longer milling times producing a smaller grain size. In a particular embodiment of the invention, the powder was ball milled for 70 hours in n-heptane. Alternatively, the powder can be ball milled in an inert atmosphere, such as argon.

The term “nanoparticles” refers to particles ranging from about 5 nm to about 500 nm in diameter. In one embodiment, the size of the synthesized nanoparticles ranges from about 10 nm to about 100 nm. In another embodiment, the size of the synthesized nanoparticles ranges from about 28 nm to about 50 nm. In yet another embodiment, the average size of the synthesized nanoparticles is about 5, 10, 15, 20, 25, 30, 35, 40, 50, 75, 100, 200 or 500 nm.

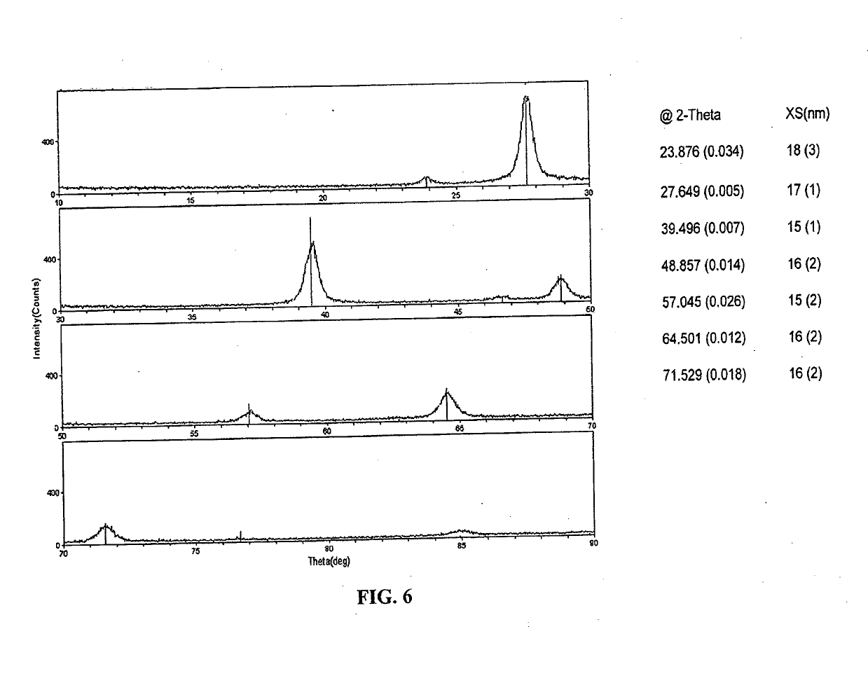

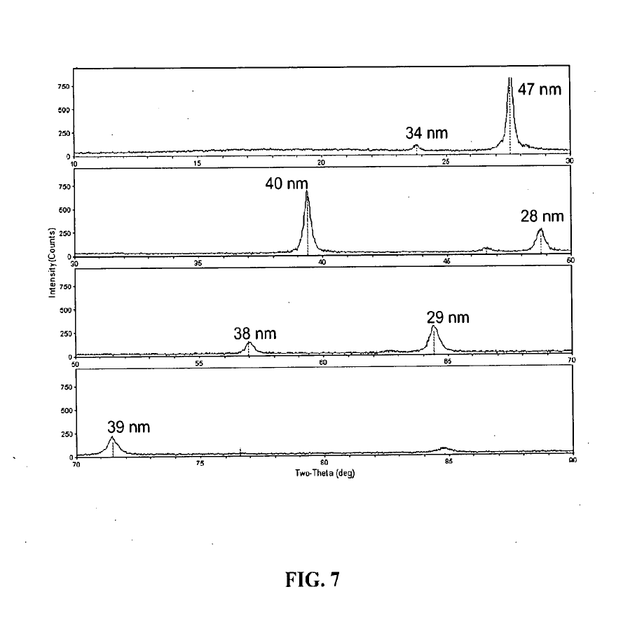

In the embodiment illustrated in FIG. 6, the grain size of the nanoparticles ranges between 15 and 18 nm. As illustrated in FIG. 7, the crystallite size of the sample as estimated from the XRD pattern using Reitveld analysis is below 50 nm.

### Coating of Nanoparticles

As illustrated in FIG. 1, item 105, the synthesized nanoparticles are subjected to further processing. In the present invention, as illustrated in item 105, the synthesized nanoparticles are coated with a second thermoelectric material, which is different from the material of the synthesized nanoparticles. Examples of second thermoelectric materials for coating the nanoparticles include, but are not limited to, PbTe, PbSe, PbS, SnTe, SnSe, EuTe, La₂Te, PbEuTe, BiSb, Bi₂Te₃, Bi₂Se₃, Sb₂Te₃, Sb₂Se₃ and their alloys. Examples of second thermoelectric materials also include, but are not limited to, SiGe, Zn₄Sb₃, and CoSb₃. It is not necessary that the coating be complete or defect-free. Thus, the nanoparticles may be completely encapsulated by the second thermoelectric material, or they may be partially or porously coated.

The nanoparticles may be coated by any of the various coating methods known to one skilled in the art. Suitable coating methods include, but are not limited to, chemical vapor deposition, sputtering, sonochemical deposition, and chemical and thermal precipitation methods based on the reaction or decomposition of inorganic or organometallic precursors. For example, thermoelectric nanoparticles are heated in the presence of lead oleate and trioctylphosphine selenide to generate a lead selenide coating. In general, methods suitable for generation of nanoparticles are suitable for generation of a coating, so long as the concentration of the second thermoelectric material in the generating solution does not reach the critical concentration at which homogeneous nucleation and particle formation take place. Ideally, the generating solution is supersaturated in the coating material, and heterogeneous nucleation and precipitation occur only on the surface of the particles of the first thermoelectric material.

In preferred embodiments, the second thermoelectric material is deposited under sonochemical conditions. The surface of the nanoparticles can optionally be modified with a ligand in order to promote nucleation of the second thermoelectric material on the particle surfaces. Ionic ligands, such as carboxylates, are thought to anchor the cationic component of the second thermoelectric material, e.g. the Pb⁺² ion in a PbSe generating system, to the surface of the core particles, increasing the local concentration and thereby favoring PbSe formation at the surface of the particles. Suitable ligands include but are not limited to oxalate, succinate, and other carboxylate ligands. In one embodiment, a suspension of the second thermoelectric materials is sonicated for about 5 minutes to achieve uniform deposition of a second thermoelectric material film on the nanoparticles. In some embodiments, potassium oxalate may be present in the solvent during formation of the nanoparticles. In some embodiments, other salts of oxalic acid (or other carboxylic acid salts) that are a soluble in the reaction mixture can also be used.

### Densification of Nanoparticles

According to one embodiment of the invention, the coated nanoparticles are densified or consolidated in order to form a bulk thermoelectric composition. The objective of densification is to produce dense thermoelectric materials while maintaining the nanoscale features. Higher density in the bulk material is associated with higher electrical conductivity and mechanical strength. The densification or consolidation may be performed by any of the various methods known to those skilled in the art. Preferably, excessive temperatures are avoided, in order to preserve the nanoscale features, like grain size and the coating on the nanoparticles. In the case of PbSe-coated PbTe particles, high temperatures should be avoided in order to minimize any alloying of PbTe with PbSe that might lead to the destruction of the low-dimensionality in these materials.

Suitable consolidation processes include but are not limited to pressure consolidation from a suspension, cold isostatic pressing (CIPing), hot isostatic pressing (HIPing), dynamic or shock compaction, thermal sintering, hot pressing, sinter forging, and hot rolling. In the first two approaches, the material is consolidated purely by mechanical deformation, without thermal treatment. Thermal sintering relies on thermal treatment without mechanical deformation. In HIPing, hot rolling, and hot pressing, both thermal treatment and pressure are used in order to achieve desired densification. Shock compression involves very brief application of very high pressure and the associated transient heating.

For PbTe nanoparticles, best results are obtained by a densification process employing both elevated temperatures and pressure. The consolidation of the particles is performed at a predetermined pressure and at a predetermined temperature for a predetermined time. In one embodiment, the pressure ranges from about 10,000 psi to about 40,000 psi. In another embodiment, the pressure ranges from about 25,000 psi to about 30,000 psi. Using these methods, samples having 95% of the theoretical density are obtained at temperatures as low as 250° C.

The consolidation temperature varies with the identity of the first and second thermoelectric materials making up the nanoparticles. In general, any temperature that yields a densified bulk thermoelectric material at a reasonable pressure within an acceptable time is suitable. In most embodiments, the temperature will be between about 100° C. and about 500° C. In certain embodiments, the temperature ranges from about 200° C. to about 250° C. In a preferred embodiment, for PbTe particles, the temperature ranges from about 350° C. to about 375° C. The elevated pressure and temperature may be maintained for any time period that yields a sufficiently dense bulk thermoelectric material. Typically, densification times range from about 30 minutes to about 240 minutes, and can in some embodiments range from about 60 minutes to about 120 minutes.

In one embodiment, the nanoparticles are placed in a uniaxial press having a die (e.g., a stainless steel die) cavity of predetermined dimension and a plunger for applying the predetermined pressure. In one embodiments, the chamber is first pumped and then backfilled with a reducing atmosphere of Ar/5% H₂. The chamber pressure is maintained at approximately 300 millitorr. A maximum uniaxial pressure ranging from about 25,000 psi to about 30,000 psi is applied during the hot press operation.

Density measurements for the samples can be performed using Archimedes' principle. The density of the thermoelectric compositions of the invention ranges from about 80% up to 100% of theoretical density of the composition.

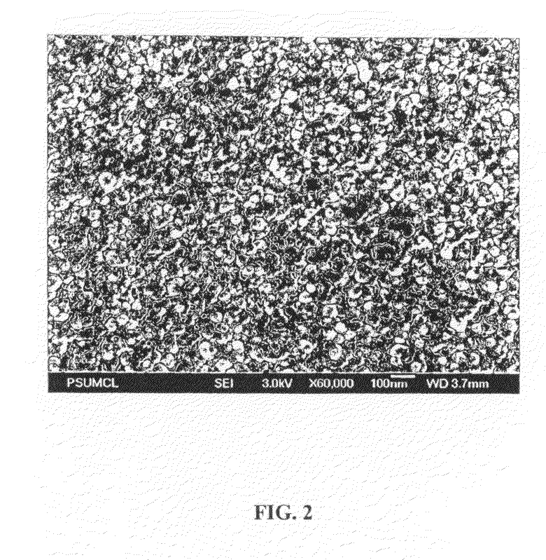

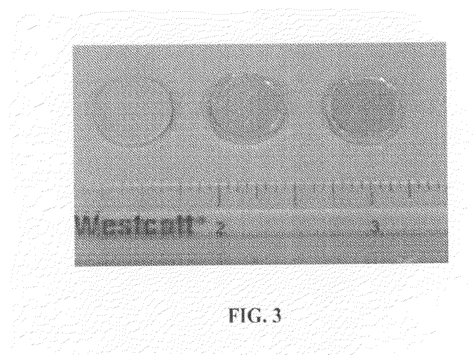

FIG. 2 is a transmission electron microscope (TEM) image of the hotpressed nanoparticles. FIG. 3 presents a photograph of several bulk samples fabricated using the hot pressing approach. These 12.5 mm by ˜2 mm pellets have a metallic appearance after hot pressing.

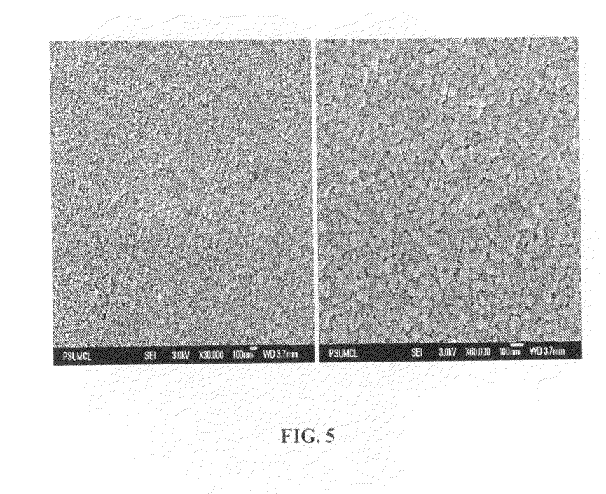

FIG. 5 displays the microstructure of a coated PbTe sample that was hot pressed at 250° C. with a pressure of about 30,000 psi to about 92% of the theoretical density.

The thermoelectric power or the Seebeck coefficient (S) can be measured by placing the sample between two Ni-plated Cu blocks. The temperature of the blocks is maintained at about 130° C. and about 30° C. or about 100° C. of thermal gradient (ΔT). The voltage output (ΔV) and temperatures at the hot (T_{H}) and cold end (T_{C}) are recorded. The Seebeck coefficient may obtained by dividing the measured voltage by the ΔT between T_{H} and T_{C}.

In some embodiments, the densified bulk thermoelectric composition provides thermoelectric power of more than 150 μV/° C. In one embodiment, the densified bulk thermoelectric composition provides thermoelectric power up to 550 μV/° C. In another embodiment, the densified bulk thermoelectric composition provides thermoelectric power ranging from about 450 μV/° C. to about 550 μV/° C. In yet another embodiment, the densified bulk thermoelectric composition provides thermoelectric power ranging from about 500 μV/° C. to about 550 μV/° C.

Accordingly, the invention provides a thermoelectric generator comprising a bulk thermoelectric composition of the invention, disposed between and in thermal contact with a heat source and a heat sink. The invention also provides a thermoelectric cooler comprising a bulk thermoelectric composition of the invention, disposed between and in electrical contact with a positive electrode and a negative electrode. The generators and coolers of the invention may optionally further comprise voltage- or current-regulating circuitry, as is well-known in the art.

### EXAMPLES

The following examples are intended for illustration purposes only, and should not be construed as limiting the scope of the invention in any way.

### Example 1

Synthesis of Nanoparticles from NaHTe

A special sonochemical vessel, configured as a closed system, was used for these experiments. The reaction mixture was cooled with an ice bath during sonication to minimize aggregation of nanoparticles formed. Lead (II) acetate and freshly prepared NaHTe were used as precursors with ethylene glycol as a solvent. A stoichiometric amount lead(II) acetate was first dissolved in ethylene glycol. The desired amount of tellurium (as NaHTe) was then added to this solution and the mixture was well stirred and poured into the sonochemical vessel. The sonochemical vessel containing the mixture was then attached to sonication horns capable of producing oscillations with frequency 20 kHz with maximum power of 500 watts. The vessel was flushed with nitrogen gas, maintaining the contents under a nitrogen atmosphere. The pH of the solution was adjusted by addition of a small amount of ethylenediamine. The mixture was sonicated for 10 minutes.

### Example 2

The method of example 1 was employed, but the mixture was sonicated for 20 minutes.

### Example 3

The method of example 1 was employed, but the mixture was sonicated for 30 minutes.

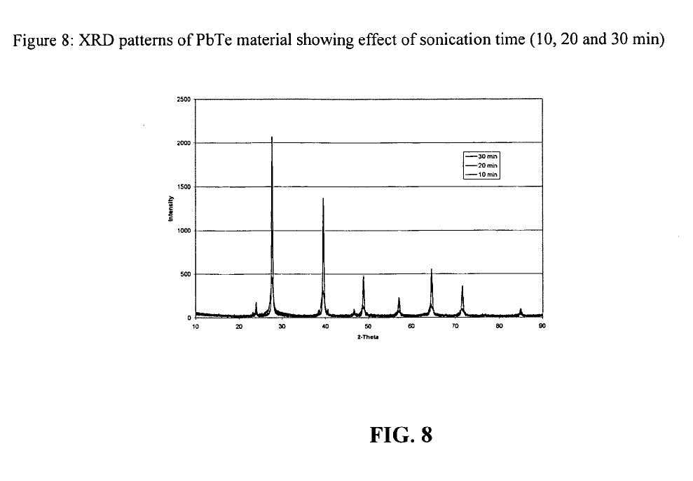

FIGS. 6 and 8 illustrate x-ray diffraction (XRD) patterns for PbTe nanoparticles synthesized by using the processes described above. In one example, the crystallite size as estimated from the line broadening by using Reitveld analysis was about 15-20 nm.

The crystallite size was estimated from the XRD pattern by using the Debye-Scherr formula. Surface area was measured using a multipoint BET technique. The equivalent spherical diameter was calculated from the surface area by assuming all particles to be spheres with equal diameter.

Table 1 summarizes the surface area, equivalent spherical diameter and the estimated crystallite size obtained at varying sonication times. The differences in the equivalent spherical diameter and the crystallite size may be an artifact in that the particles are not spherical but faceted, as shown later by TEM.

TABLE 1

| | | | Equivalent | Crystallite |
|---|---|---|---|---|
| | | | spherical | size from XRD |
| Sample | Sonication | Surface | diameter | (Debye-Scherr |
| name | time (min) | area (m²/g) | (nm) | formula) (nm) |
| PbTe5-A4 | 10 | 37.3 | 19.7 | 10 |
| PbTe5-A5 | 20 | 19.1 | 38 | 25 |
| PbTe5-A6 | 30 | 12.1 | 60 | 40 |

As shown in Table 1, in these experiments, the surface area decreased with increasing sonication time, accompanied by an increase in both particle and crystallite size.

### Example 4

### Coating of Nanoparticles

This example utilizes the modification of the PbTe surface with oxalate ligand and deposition of PbSe under sonochemical conditions. PbTe nanoparticles were prepared by the method of Example 1, modified by the addition of potassium oxalate to the ethylene glycol during formation of PbTe nanoparticles. Lead(II) acetate dissolved in ethylene glycol and NaHSe (PbTe:PbSe ratio 100:1) were then added to the colloid, and the mixture was sonicated for an additional 5 minutes to achieve uniform deposition of PbSe films on the PbTe nanoparticles.

### Example 5

The coating process as in Example 4 repeated with a PbTe:PbSe ratio of 10:1.

### Example 6

The coating process as in Example 4 repeated with a PbTe:PbSe ratio of 5:1.

### Example 7

The coating process as in Example 4 repeated with a PbTe:PbSe ratio of 3.3:1.

The effect of the Pb and Se concentrations in the coating step was investigated, and it was found that best results were obtained when the concentrations of Pb and Se were low. High concentrations of PbSe (greater than ca. 5 g/liter) lead to homogeneous nucleation and the formation of separate PbSe nanoparticles. The XRD pattern of the PbSe-coated PbTe particles obtained with higher concentration of Pb and Se showed the presence of a crystalline PbSe phase. At low concentrations, where efficient coating is observed, peaks corresponding to PbSe were absent. However, as the particles were heated to 250° C., peaks corresponding to crystalline PbSe were observed, indicating the conversion of an amorphous PbSe coating layer to a crystalline layer. Inductively coupled plasma spectroscopy studies indicated the presence of Pb, Te and Se in these nanoparticles.

### Example 8

### Consolidation/Densification of Nanoparticles

A pressure assisted sintering technique at moderate temperatures was used for consolidation of the nanoparticles. Both pure PbTe and coated PbTe nanoparticles were densified using this technique. In this example hot pressing was used as a pressure assisting sintering technique.

The nanoparticles were pressed in a stainless steel die that had been preheated to the desired temperature. The chamber was evacuated and then backfilled with a reducing atmosphere of Ar/5% H₂. The chamber pressure was maintained at 300 millitorr. A maximum uniaxial pressure of 25,000-30,000 psi was then applied. Dense PbTe and PbTe/PbSe pellets having densities of 90-95% of theoretical were obtained at temperatures of 250° C. to 260° C. The powders were pressed uniaxially in a die. Density measurements for the samples were done using Archimedes' principle. FIG. 3 is a photograph of several samples fabricated using the hot pressing approach. The 12.5 mm by ˜2 mm pellets have a metallic appearance after hot pressing.

Field Emmision Scanning Electron Microscopy images of a fracture surface revealed a uniform microstructure and grain sizes below 50 nm.

### Thermoelectric Properties

Electrical conductivity at room temperature was estimated by the four point probe technique (ASTM Specification FA3-83). The thermoelectric power or the Seebeck coefficient was measured by placing the sample between two Ni-plated Cu blocks. The temperatures of the blocks were maintained at 130° C. and 30° C., respectively, or about 100° C. of thermal gradient (ΔT). The voltage output and temperatures at the hot (T_{H}) and cold end (T_{c}) were recorded. The Seebeck coefficient was obtained by dividing the voltage by the measured ΔT. Thermal conductivity was estimated from the thermal diffuisivity, specific heat and density of the sample; thermal diffusivity was measured by using a laser flash diffusivity method. The specific heat was measured with a PerkinElmer® Differential Scanning Calorimeter.

Depending on the processing conditions and composition, the thermoelectric power or Seebeck coefficient was found to vary from about 174 to about 546 μV/K. The electrical conductivity was found to vary between about 9 mΩ-cm to about 2.2 Ω-cm. Two samples were used to measure thermal conductivity. For material made from uncoated PbTe nanoparticles, the thermal conductivity was about 0.01165 W-cm⁻¹ K⁻¹. For the coated PbTe particles the thermal conductivity was found to drop to about 0.00803 W-cm-⁻¹ K⁻¹. The lowering of the thermal conductivity in PbTe/PbSe samples may be attributed to the increased scattering of phonons at the PbTe/PbSe interfaces.

As a reference, conventional p-type PbTe with micron size grains has a Seebeck coefficient of approximately 80-100 μV/K, an electrical conductivity of approximately 1-2 mΩ-cm and a thermal conductivity of about 0.015 W-cm⁻¹ K⁻¹.

High thermoelectric power was observed for samples that. were hot pressed at 250-260° C. The highest thermoelectric power (about 550 μV/K) was obtained from samples made from PbSe-coated PbTe nanoparticles (PbTe:PbSe ratio 100:1) that were hot pressed at 250° C. This was 5 to 10 times that of standard PbTe material.

### Example 9

The process described in Example 8 was carried out, except that the pellets were pressed at temperatures of 350° C. to 375° C. Table 2 provides the density and thermoelectric properties of samples produced at hot pressing temperatures of 350° C., 360° C., and 375° C., respectively.

TABLE 2

| | Hot pressing | | |
|---|---|---|---|
| Sample | Temperature | Seebeck | Resistivity |
| name | (° C.) | (μV/K) | (mOhm-cm) |
| TEM-225 | 350 | 441 | 105 |
| TEM-252 | 360 | 420 | 104 |
| TEM-294 | 375 | 390 | 52 |

While the foregoing invention has been described in some detail for purposes of clarity and understanding, it will be appreciated by one skilled in the art, from a reading of the disclosure, that various changes in form and detail can be made without departing from the true scope of the invention as set out in the appended claims.

We claim:

1. A bulk thermoelectric composition comprising nanoparticles of a first thermoelectric material, wherein the surface of said nanoparticles is coated with a second thermoelectric material.

2. The composition of claim 1, wherein the average size of the nanoparticles is less than 500 nm.

3. (canceled)

4. (canceled)

5. (canceled)

6. (canceled)

7. The bulk thermoelectric composition of claim 1, wherein the density of said composition ranges from about 80% to about 100% of the theoretical density.

8. The bulk thermoelectric composition of claim 1, wherein said composition is capable of generating a potential of more than 100 μV/° C.

9. (canceled)

10. (canceled)

11. The composition of claim 1, wherein the first thermoelectric material is selected from the group consisting of PbTe, PbSe, PbS, SnTe, SnSe, EuTe, La₂Te₃ PhEuTe, BiSb, Bi₂Te₃, Bi₂Se₃, Sb₂Te₃, Sb₂Se₃, SiGe, Zn₄Sb₃, and CoSb₃.

12. The composition of claim 11, wherein the first thermoelectric material is PbTe.

13. The composition of claim 1, wherein the second thermoelectric material is selected from the group consisting of PbTe, PbS, PbSe SnTe, SnSe, EuTe, La₂Te, PbEuTe, BiSb, Bi₂Te₃, Bi₂Se₃, Sb₂Te₃, Sb₂Se₃, SiGe, Zn₄Sb₃, and CoSb₃.

14. The composition of claim 1, wherein the second thermoelectric material is PbSe.

15. A method of manufacturing a bulk thermoelectric composition, comprising the steps of: (a) coating a plurality of nanoparticles of a first thermoelectric material with a second thermoelectric material; and (b) consolidating the coated nanoparticles to form a bulk thermoelectric composition.

16. The method of claim 15, wherein the nanoparticles are generated by sonication.

17. The method of claim 16, wherein the step of coating is performed by sonochemical deposition of the second thermoelectric material on the surface of said nanoparticles.

18. The method of claim 17, wherein said nanoparticles are in contact with an oxalate ligand during the step of coating with the second thermoelectric material.

19. The method of claim 15, wherein the step of consolidating is performed by warm-pressing the nanoparticles at a pressure ranging from about 25,000 psi and about 30,000 psi.

20. The method of claim 15, wherein the step of consolidating is performed at a temperature between about 100° C. and about 500° C.

21. The method of claim 15, wherein the average size of said nanoparticles is less than 500 nm.

22. (canceled)

23. (canceled)

24. (canceled)

25. The method of claim 15, wherein the density of said bulk thermoelectric composition ranges from about 80% to about 100% of theoretical density.

26. (canceled)

27. (canceled)

28. (canceled)

29. The method of claim 15, wherein the first thermoelectric material is selected from the group consisting of PbSe, PbS, PbTe, SnTe, SnSe, EuTe, La₂Te, PbEuTe, BiSb, Bi₂Te₃, Bi₂Se₃, Sb₂Te₃, Sb₂Se₃, SiGe, Zn₄Sb₃, and CoSb₃.

30. The method of claim 29, wherein the first thermoelectric material is PbTe.

31. The method of claim 15, wherein the second thermoelectric material is selected from the group consisting of PbTe, PbS, PbSe, SnTe, SnSe, EuTe, La₂Te, PbEuTe, BiSb, Bi₂Te₃, Bi₂Se₃, Sb₂Te₃, Sb₂Se₃, SiGe, Zn₄Sb₃, and CoSb₃.

32. The method of claim 31, wherein the second thermoelectric material is PbSe.

33. (canceled)

34. (canceled)

35. (canceled)

36. (canceled)

37. (canceled)
